(19) United States
(12) Patent Application Publication
(10) Pub. No.: US 2019/0147652 A1
(43) Pub. Date: May 16, 2019

(54) AUGMENTED REALITY DEVICE

(71) Applicant: METAL INDUSTRIES RESEARCH & DEVELOPMENT CENTRE, Kaohsiung City 811 (TW)

(72) Inventors: Jui-Ting Chien, Kaohsiung City (TW); Sheng-Hsiu Tseng, Kaohsiung City (TW); Cheng-Huan Chen, Taoyuan City (TW)

(21) Appl. No.: 15/854,132

(22) Filed: Dec. 26, 2017

(30) Foreign Application Priority Data
Nov. 13, 2017 (TW) 106139221

(51) Int. Cl. G06T 19/00; G02B 27/01

(52) U.S. Cl. CPC G06T 19/006; G02B 2027/0178; G02B 27/0176; G02B 27/0172

(57) ABSTRACT

An augmented reality device, which is wearable on a user for merging virtual and real images, includes a virtual image projection module and a front cover. A display of the virtual image projection module is provided to generate and project first and second image lights to a light-path dividing means. The first and second image lights passed through the light-path dividing means are respectively projected to first and second reflective elements which are configured to respectively reflect the first and second image lights to the front cover. The front cover is provided to reflect the first and second image lights to the user's eyes for generating the virtual image. Furthermore, the light outside the augmented reality device can pass through the front cover and project on the user's eyes for generating the real image, such that the user can see the virtual and real images simultaneously.

### FIELD OF THE INVENTION

This invention generally relates to an augmented reality device which is utilized to generate virtual images and allow user to see virtual and real images at the same time.

### BACKGROUND OF THE INVENTION

Taiwan patent application no. 105218538 discloses a transmissive eyepiece applied to near-eye display, and the transmissive eyepiece includes a first prism, a second prism and a partial-reflective coating. A first connection surface of the first prism is connected to a second connection surface of the second prism, and the partial-reflective coating is positioned between the first and second connection surfaces. The partial-reflective coating is adapted to increase the travel distance and view angle of the light in the first and second prisms.

However, owing to the transmissive eyepiece is produced by connecting the first and second prisms, the inclination angles of the first and second connection surfaces have to be matched for the partial-reflective coating to reflect light. When the inclination angles cannot match or there is a gap between the first and second connection surfaces, the virtual image will appear to be out of focus or blurry, even fail to form the virtual image. Furthermore, in order to increase the travel distance of the light in the first and second prisms, the thicknesses of the first and second prisms have to be increased, but that will also increase the weight of the transmissive eyepiece.

In conventional augmented reality device, two displays are required and respectively controlled by different drive circuits. And the two displays may increase the weight of the conventional augmented reality device and cause discomfort of the user because they have to be mounted outside the user's eyes respectively.

### SUMMARY

The primary object of the present invention is to allow user to see virtual and real images simultaneously and reduce the weight and volume of the augmented reality device. Additionally, the present invention can shorten the light reflection path to improve virtual image definition.

The augmented reality device of the present invention is wearable on a user and includes a virtual image projection module and a front cover. The virtual image projection module includes a display, a light-path dividing means, a first reflective element and a second reflective element. The light-path dividing means is located between the display and the first reflective element and between the display and the second reflective element. The display is configured to generate and project a first image light and a second image light to the light-path dividing means. The light-path dividing means is configured to divide and respectively project the first and second image lights to the first and second reflective elements. The first reflective element is configured to reflect the first image light passed through the light-path dividing means, and the second reflective element is configured to reflect the second image light passed through the light-path dividing means. The front cover includes a first reflective region and a second reflective region. The first image light reflected by the first reflective element is projected to the first reflective region, and the second image light reflected by the second reflective element is projected to the second reflective region. For generating a virtual image, the first reflective region is configured to reflect the first image light to one eye of the user and the second reflective region is configured to reflect the second image light to the other eye of the user. And a light outside the augmented reality device is configured to pass through the front cover and project on the user's eyes for generating a real image which is merged with the virtual image.

The augmented reality device utilizes the display and the light-path dividing means to generate and divide the first and second image lights, allowing the first and second image lights to project to the first and second reflective elements respectively. For this reason, a single drive circuit can be used to control the display in the augmented reality device and reduce the weight and volume of the augmented reality device to prevent the user from feeling discomfort.

In addition, the augmented reality device uses the first reflective element, the second reflective element and the front cover to reflect the first and second image lights generated by the display to the user's eyes respectively for generating the virtual image, so can reduce the distance between the reflective element and the display to improve the definition of the virtual image. And the weight and volume of the augmented reality device can be reduced by reducing the thicknesses of the reflective elements because they are provided to reflect the first and second image lights only.

### DESCRIPTION OF THE DRAWINGS

FIG. 1 is a schematic diagram illustrating an augmented reality device in accordance with one embodiment of the present invention.

FIG. 2 is a schematic diagram illustrating the augmented reality device in accordance with one embodiment of the present invention.

### DETAILED DESCRIPTION OF THE INVENTION

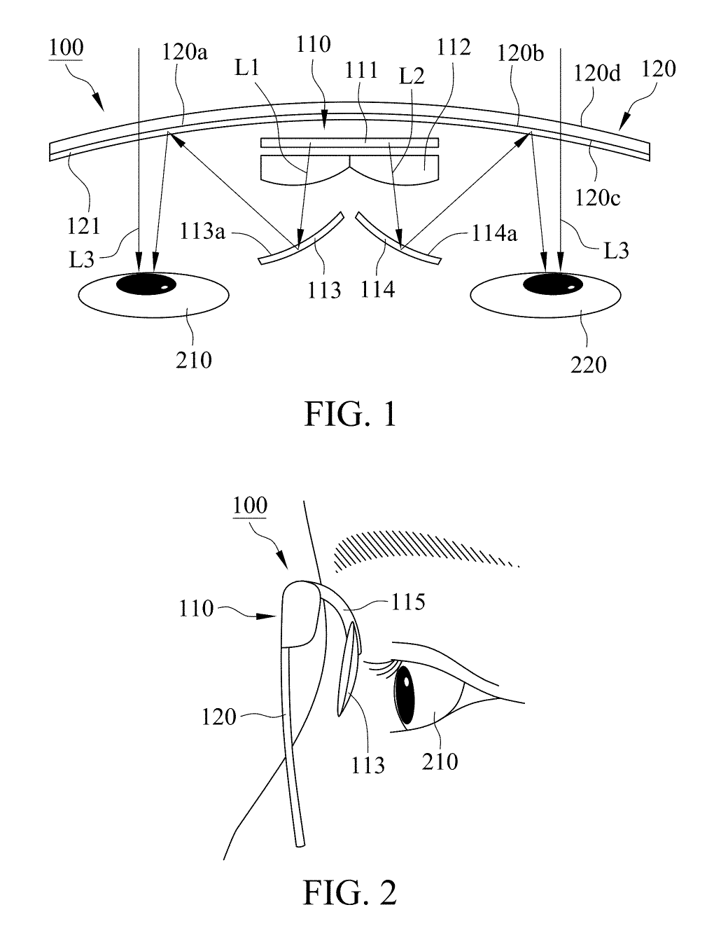

With reference to FIGS. 1 and 2, an augmented reality device 100 of the present invention is wearable on a user for generating a virtual image. The user can simultaneously see the virtual image merged with a real image by the augmented reality device 100.

With reference to FIGS. 1 and 2, the augmented reality device 100 includes a virtual image projection module 110 and a front cover 120. In this embodiment, the front cover 120 is located in front of the user's eyes and in the sight-of-line direction of the user when the augmented reality device 100 is wore on the user. And the front cover 120 is made of glass, resin or polycarbonate (PC).

With reference to FIGS. 1 and 2, the virtual image projection module 110 includes a display 111, a light-path dividing means 112, a first reflective element 113 and a second reflective element 114. In this embodiment, the display 111 is located between the front cover 120 and the first reflective element 113 and located between the front cover 120 and the second reflective element 114. However, the display 111 may be located in front of the front cover 120 in other embodiments, such that the front cover 120 is located between the display 111 and the first reflective element 113 and located between the display 111 and the second reflective element 114.

With reference to FIGS. 1 and 2, the display 111, which may be an organic light-emitting diode (OLED) panel, is provided to generate a first image light L1 and a second image light L2. The light-path dividing means 112 is located between the display 111 and the first reflective element 113 and located between the display 111 and the second reflective element 114. The light-path dividing means 112 is, but not limited to, composed of two lenses.

With reference to FIGS. 1 and 2, the first and second image lights L1 and L2 from the display 111 are respectively projected to the light-path dividing means 112. The light-path dividing means 112 is configured to divide the first and second image lights L1 and L2, allowing the first image light L1 passed through the light-path dividing means 112 to project to the first reflective element 113 and allowing the second image light L2 passed through the light-path dividing means 112 to project to the second reflective element 114.

With reference to FIGS. 1 and 2, the first reflective element 113 has a first reflective surface 113a and the second reflective element 114 has a second reflective surface 114a, and the first and second reflective surfaces 113a and 114a both face toward the front cover 120. Preferably, the first and second reflective elements 113 and 114 are concave lenses.

With reference to FIGS. 1 and 2, the first reflective element 113 is arranged to reflect the first image light L1 passed through the light-path dividing means 112 to the front cover 120, and the second reflective element 114 is arranged to reflect the second image light L2 passed through the light-path dividing means 112 to the front cover 120. In this embodiment, the first and second image lights L1 and L2 are reflected by the first reflective surface 113a of the first reflective element 113 and the second reflective surface 114a of the second reflective element 114, respectively. With reference to FIGS. 1 and 2, the virtual image projection module 110 further includes a supporter 115, which is detachable mounted on the front cover 120. The first and second reflective elements 113 and 114 are mounted on the supporter 115. Preferably, the first and second reflective elements 113 and 114 are located above the user's nose bridge when the augmented reality device 100 is wore on the user, and they are respectively located at left and right front of the user's nose bridge.

With reference to FIGS. 1 and 2, there are a first reflective region 120a and a second reflective region 120b on the front cover 120. The first reflective region 120a is positioned in front of one eye 210 of the user and the second reflective region 120b is positioned in front of the other eye 220 of the user. And the first and second reflective regions 120a and 120b are located in a line-of-sight direction of user. The first image light L1 reflected by the first reflective element 113 is projected to the first reflective region 120a, and the second image light L2 reflected by the second reflective element 114 is projected to the second reflective region 120b. For generating a virtual image, the first and second reflective regions 120a and 120b are provided to respectively reflect the first and second image lights L1 and L2 to the eyes 210 and 220 of the user.

With reference to FIGS. 1 and 2, the front cover 120 includes a first surface 120c, a second surface 120d and a reflective layer 121. In this embodiment, the reflective layer 121 is coated on the first surface 120c, and the first surface 120c is located between the reflective layer 121 and the second surface 120d. The reflective layer 121 on the front cover 120 is utilized to reflect the first and second image lights L1 and L2, respectively, and the reflective layer 121 may be a multi-layer coating of alternate high and low refractive index. The average reflectivity of the multi-layer coating is greater than 50% for RGB light from the display which wavelengths are within the range from 400 nm to 700 nm.

With reference to FIGS. 1 and 2, a light L3, outside the augmented reality device 100, can pass through the front cover 120 and project to the eyes 210 and 220 of user for generating a real image, such that the virtual image can be merged with the real image.

With reference to FIGS. 1 and 2, owing to the first and second image lights L1 and L2 are both generated by the display 111, the augmented reality device 100 can use a single drive circuit to control the display 111, such that the weight and volume of the augmented reality device 100 can be reduced and the user may feel more comfortable when wearing the augmented reality device 100. Additionally, the augmented reality device 100 utilizes the first reflective element 113, the second reflective element 114 and the front cover 120 to respectively reflect the first and second image lights L1 and L2 to the eyes 210 and 220 of the user, so can reduce the distance between the first reflective element 113 and the display 111 and the distance between the second reflective element 114 and the display 111 for significantly improving the definition of the virtual image. Furthermore, because the first and second reflective elements 113 and 114 are only provided to reflect the first and second image lights L1 and L2, the thicknesses of the first and second reflective elements 113 and 114 can be reduced to reduce the weight and volume of the augmented reality device 100.

With reference to FIGS. 1 and 2, the first and second image lights L1 and L2 are respectively reflected to the user's eyes 210 and 220 by the first and reflective element 113, the reflective element 114 and the front cover 120, thus the first and second reflective elements 113 and 114 will not block the view of the user and the real image, and the virtual image can be effectively merged with the real image for augmented reality.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. An augmented reality device wearable on a user, comprising:
a virtual image projection module including a display, a light-path dividing means, a first reflective element and a second reflective element, the light-path dividing means is located between the display and the first reflective element and between the display and the second reflective element, wherein the display is configured to generate and respectively project a first image light and a second image light to the light-path dividing means, the light-path dividing means is configured to divide the first and second image lights and configured to project the first image light to the first reflective element and project the second image light to the second reflective element, the first reflective element is configured to reflect the first image light passed through the light-path dividing means, and the second reflective element is configured to reflect the second image light passed through the light-path dividing means; and
a front cover including a first reflective region and a second reflective region, the first image light reflected by the first reflective element is projected to the first reflective region and the second image light reflected by the second reflective element is projected to the second reflective region, wherein the first reflective region is configured to reflect the first image light to one eye of the user and the second reflective region is configured to reflect the second image light to the other eye of the user for generating a virtual image, and wherein a light outside the augmented reality device is configured to pass through the front cover and project to the user's eyes for generating a real image which is merged with the virtual image.

2. The augmented reality device in accordance with claim 1, wherein the display is located between the front cover and the first reflective element and between the front cover and the second reflective element.

3. The augmented reality device in accordance with claim 1, wherein the first reflective element includes a first reflective surface and the second reflective element includes a second reflective surface, and the first and second reflective surfaces face toward the front cover.

4. The augmented reality device in accordance with claim 1, wherein the front cover includes a reflective layer, and the reflective layer is configured to reflect the first and second image lights.

5. The augmented reality device in accordance with claim 4, wherein the reflective layer is a multi-layer coating of alternate high and low refractive index and has an average reflectivity greater than 50% for RGB light from the display which wavelengths are within the range from 400 nm to 700 nm.

6. The augmented reality device in accordance with claim 1, wherein the virtual image projection module further includes a supporter, and the first and second reflective elements are mounted on the supporter.

7. The augmented reality device in accordance with claim 6, wherein the supporter is detachable mounted on the front cover.

8. The augmented reality device in accordance with claim 4, wherein the front cover includes a first surface and a second surface, the reflective layer is coated on the first surface, and the first surface is located between the reflective layer and the second surface.

9. The augmented reality device in accordance with claim 1, wherein the front cover is located between the display and the first reflective element and between the display and the second reflective element.

10. The augmented reality device in accordance with claim 1, wherein the first reflective region is located in front of one eye of the user and the second reflective region is located in front of the other eye of the user, and the first and second reflective regions are located in a line-of-sight direction of the user.
